(19) United States
(12) Patent Application Publication
(10) Pub. No.: US 2015/0255874 A1
(43) Pub. Date: Sep. 10, 2015

(54) CONICAL ANTENNA

(71) Applicant: HON HAI PRECISION INDUSTRY CO., LTD., New Taipei (TW)

(72) Inventors: CHIH-MING HUNG, New Taipei (TW); LI-YAN TSAI, New Taipei (TW); HAN-PING MI, New Taipei (TW)

(73) Assignee: HON HAI PRECISION INDUSTRY CO., LTD., New Taipei (TW)

(21) Appl. No.: 14/260,992

(22) Filed: Apr. 24, 2014

(30) Foreign Application Priority Data
Mar. 10, 2014 (TW) 103108267

(51) Int. Cl. H01Q 13/02

(52) U.S. Cl. CPC H01Q 13/02

(57) ABSTRACT

A conical antenna includes a chassis, a main radiator and a ring resonator. A central of the chassis defines a via for feeding electromagnetic signals. The main radiator includes a first radiating portion with a conical shape, a second radiating portion with a cylindrical shape and a third radiating portion with a frustum cone shape, for transmitting and receiving electromagnetic signals. The ring resonator is disposed on the chassis. A sidewall of the first radiating portion connects with a sidewall of the via in the chassis through the ring resonator. The main radiator and the ring resonator collectively resonate to generate a resonance frequency useful in mobile communications devices.

### FIELD

The disclosure relates to an antenna, and particularly to a conical antenna.

### BACKGROUND

In recent years, as demands for mobile communication products are increasing, the wireless communication technologies have developed quickly. Many communication products are small portable products. These require that components of products should also be small and have good performance. Currently, cone-shaped antennas are widely used in broadband communication applications. However, conventional cone-shaped antennas are too big to use in small portable products. Besides, the frequency band achievable by existing cone-shaped antennas remains narrow. Therefore, there is room for improvement in the art.

### BRIEF DESCRIPTION OF THE DRAWINGS

Many aspects of the presented embodiments can be better understood with reference to the following drawings. The components in the drawings are not necessarily drawn to scale, the emphasis instead being placed upon clearly illustrating the principles of the presented embodiments.

FIG. 1 is a three-dimensional schematic diagram of one embodiment of a conical antenna.

FIG. 2 is a two-dimensional schematic diagram of one embodiment of a conical antenna.

FIG. 3 is a size diagram of one embodiment of a conical antenna.

FIG. 4 is a diagram showing impedance and return loss characteristics of one embodiment of a conical antenna.

FIG. 5 is a diagram showing peak gain characteristics for an operating frequency between 700 MHz and 900 MHz of frequency of one embodiment of a conical antenna.

FIG. 6 is a diagram showing peak gain characteristics for an operating frequency between 2500 MHz and 2700 MHz of frequency of one embodiment of a conical antenna.

FIG. 7 is a diagram showing gain characteristics for an operating frequency of 800 MHz of frequency in horizontal direction of one embodiment of a conical antenna.

FIG. 8 is a diagram showing gain characteristics for an operating frequency of 800 MHz of frequency in vertical direction of one embodiment of a conical antenna.

FIG. 9 is a diagram showing gain characteristics for an operating frequency of 2600 MHz of frequency in horizontal direction of one embodiment of a conical antenna.

FIG. 10 is a diagram showing gain characteristics for an operating frequency of 2600 MHz of frequency in vertical direction of one embodiment of a conical antenna.

### DETAILED DESCRIPTION

An object of this disclosure is to describe at least one conical antenna with high performance that is small enough to be used in small communication products

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

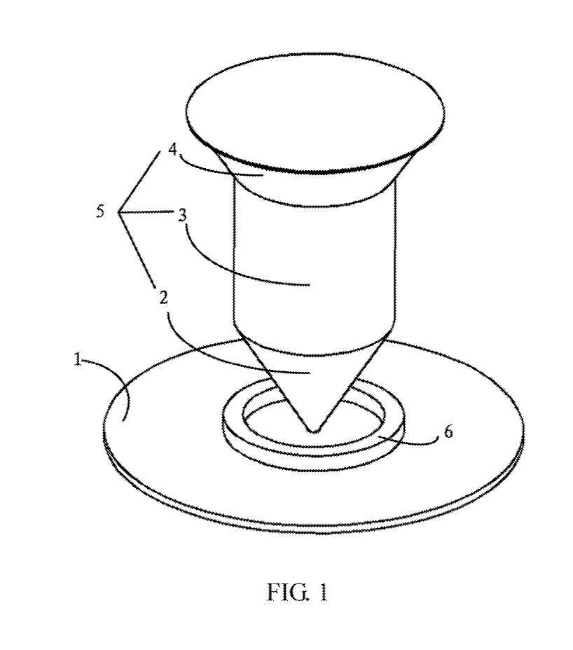

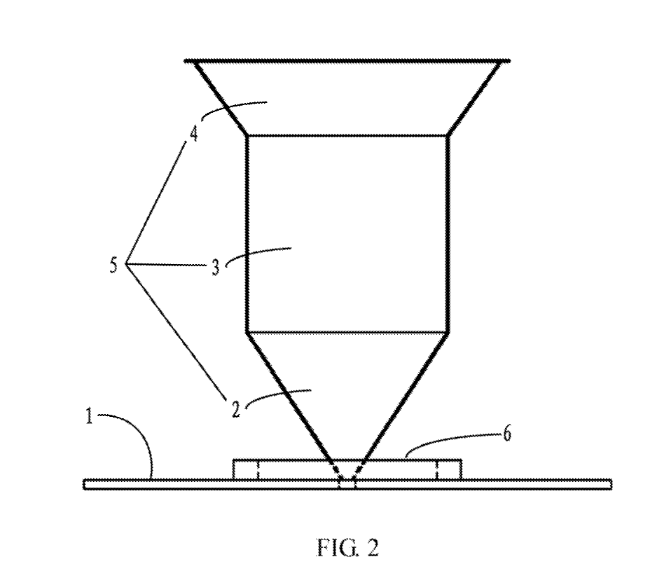

FIG. 1 is a three-dimensional schematic diagram of one embodiment of a conical antenna. FIG. 2 is a two-dimensional schematic diagram of one embodiment of a conical antenna. In one embodiment, the conical antenna comprises a chassis 1, a main radiator 5 and a ring resonator 6.

In at least one embodiment, the chassis 1 is similar to a circular shape, wherein a bottom surface and a top surface of the chassis 1 are planes parallel to each other. A central of the chassis 1 defines a via for feeding electromagnetic signals. In other embodiments, the chassis 1 may be another shape.

The main radiator 5 for transmitting and receiving electromagnetic signals can comprise a first radiating portion 2 with a conical shape, a second radiating portion 3 with a cylindrical shape and a third radiating portion 4 with a frustum cone shape.

The first radiating portion 2 with a hollow conical structure can be composed of a conductive material. A vertex portion of a cone of the first radiating portion 2 is cut by a plane which is perpendicular to a central axis of the first radiating portion 2, so that there is a hole in the vertex portion of the first radiating portion 2 and an outer diameter of the hole is equal to a diameter of the via of the chassis 1. So that a sidewall of the first radiating portion 2 connects with a sidewall of the via in the chassis 1, the central axis of the first radiating portion 2 aligns to a central axis of the chassis 1.

The second radiating portion 3 with a hollow cylindrical structure also can be composed of a conductive material. A cylindrical bottom surface of the second radiating portion 3 and a cone bottom surface of the first radiating portion 2 overlap completely so that the sidewall of the first radiating portion 2 connects a sidewall of the second radiating portion 3 together to form a curved surface.

The third radiating portion 4 with a hollow frustum cone structure can be composed of a conductive material. A surface with shorter diameter of the third radiating portion 4 overlaps with a cylindrical top surface of the second radiating portion 3 completely. So that the sidewall of the second radiating portion 3 connects a sidewall of the third radiating portion 4 together to form a curved surface.

In at least one embodiment, conductive materials of the first radiating portion 2 and the second radiating portion 3 and the third radiating portion 4 can be composed of metal materials such as copper, aluminum or some other materials made from composite conductive materials.

The first radiating portion 2 and the second radiating portion 3 and the third radiating portion 4 are connected in series. Central axes of the first radiating portion 2, the second radiating portion 3 and the third radiating portion 4 align to each other and sidewalls of the first radiating portion 2, the second radiating portion 3 and the third radiating portion 4, forming a curved surface. Thus, the central axis of the main radiator 5 aligns to axes of the first radiating portion 2 and the second radiating portion 3 and the third radiating portion 4. Impedance characteristics of the main radiator 5 can match a preset frequency band. The first radiating portion 2 of the main radiator 5 connects to the chassis 1 perpendicularly so that the central axis of the main radiator 5 aligns to the central axis of chassis 1.

The ring resonator 6 is disposed on the chassis 1 to generate a resonance frequency of electromagnetic signals resonating collectively with the main radiator 5. A ring bottom surface of the ring resonator 6 overlaps with the top surface of the chassis 1. The sidewall of the first radiating portion 2 connects with the sidewall of the via in the chassis 1 through the ring resonator 6, wherein the central axis of the first radiating portion 2 passes through a central of the ring resonator 6.

According to equation (1) and (2) shown below, and a designed frequency band width of electromagnetic signals, a mean diameter of the ring resonator 6 can be computed by:

$$\begin{matrix}φ = \frac{n \times λ g}{2 \times π} & ( 1 ) \\ λ g = \frac{c}{f \sqrt{ɛ}} & ( 2 )\end{matrix}$$

Wherein n is an integer, c is the speed of light, ε is an effective dielectric constant, φ is a mean diameter of the ring resonator 6, λg is a guided wavelength.

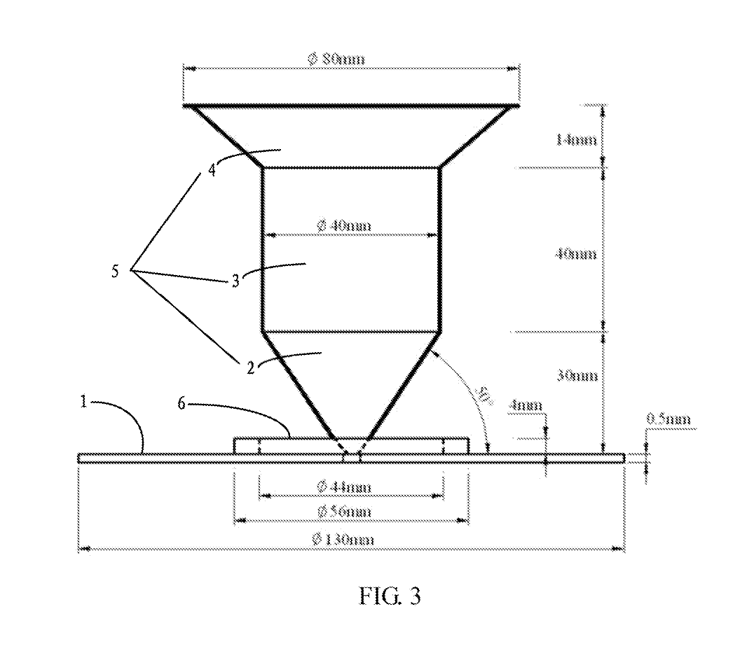

FIG. 3 is a size diagram of one embodiment of a conical antenna. In one embodiment, a diameter of the chassis 1 is 130 millimeters while thickness of the chassis 1 is 0.5 millimeter.

In the first radiating portion 2, a height of the first radiating portion 2 is 30 millimeters, a diameter of the cone bottom surface is 40 millimeters, a side face of the first radiating portion 2 has an angle of 50 degrees with the plane of the top surface of the chassis 1.

In the second radiating portion 3, a height of the second radiating portion 3 is 40 millimeters, diameters of the cylindrical bottom surface and the cylindrical top surface are 40 millimeters, they are equal to the diameter of the cone bottom surface of the first radiating portion 2 so that the sidewall of the first radiating portion 2 connects a sidewall of the second radiating portion 3 together to form a curved surface.

In the third radiating portion 4, a height of the third radiating portion 4 is fourteen millimeters, diameters of the frustum cone top surface and the frustum cone bottom surface are respectively 80 millimeters and 40 millimeters, they are equal to the diameter of the cylindrical top surface in the second radiating portion 3. So that the sidewall of the second radiating portion 3 connects a sidewall of the third radiating portion 4 together to form a curved surface.

In the ring resonator 6, a height of the ring resonator 6 is four millimeters, an outer diameter is 56 millimeters, and an inner diameter is 44 millimeters.

In one embodiment, the whole conical antenna may be integrally molded, wherein the sidewall of the main radiator 5 is composed of a conductive material and thickness of the sidewall is about 0.56 millimeter. The conical antenna can be hollow. Therefore the conical antenna is small enough to use in small portable communication products.

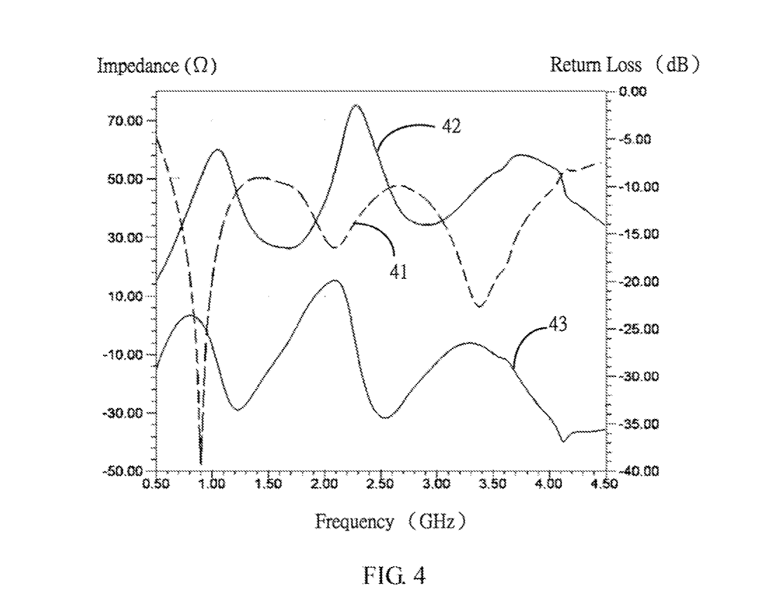

The impedance and return loss characteristics of the antenna in FIG. 1 are shown in FIG. 4. Curve 41 represents the return loss characteristics of the conical antenna, curve 42 and curve 43 represent real components and imaginary components of the impedance characteristics respectively. As can be seen from FIG. 4, in the range of frequencies from about 630 MHz to 4000 MHz, the return loss characteristics is less than −10 dB.

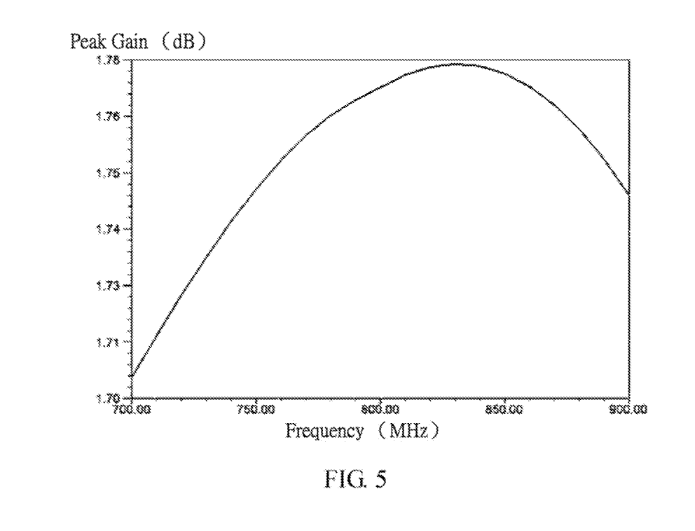

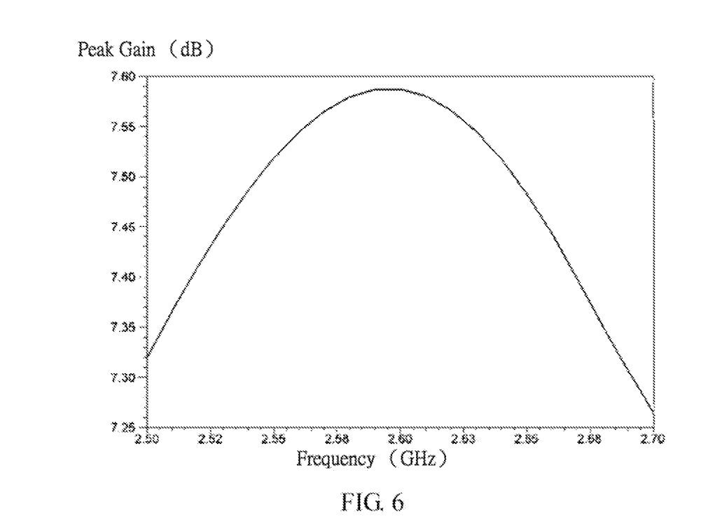

In the direction of deviating an angle of 40 degrees (θ=40 degrees) from the z-axis to the x-axis in the three-dimension, a maximum gain of a conical antenna is shown in FIG. 5 and FIG. 6 corresponding to an angle deviating an angle of 40 degrees. FIG. 5 is showing peak gain characteristics for an operating frequency between 700 MHz and 900 MHz of frequencies, while FIG. 6 is showing peak gain characteristics for an operating frequency between 2500 MHz and 2700 MHz of frequencies. As can be seen from FIG. 5 and FIG. 6, the peak gain characteristics are high and have little differences among different frequencies. The conical antenna has good gain performance.

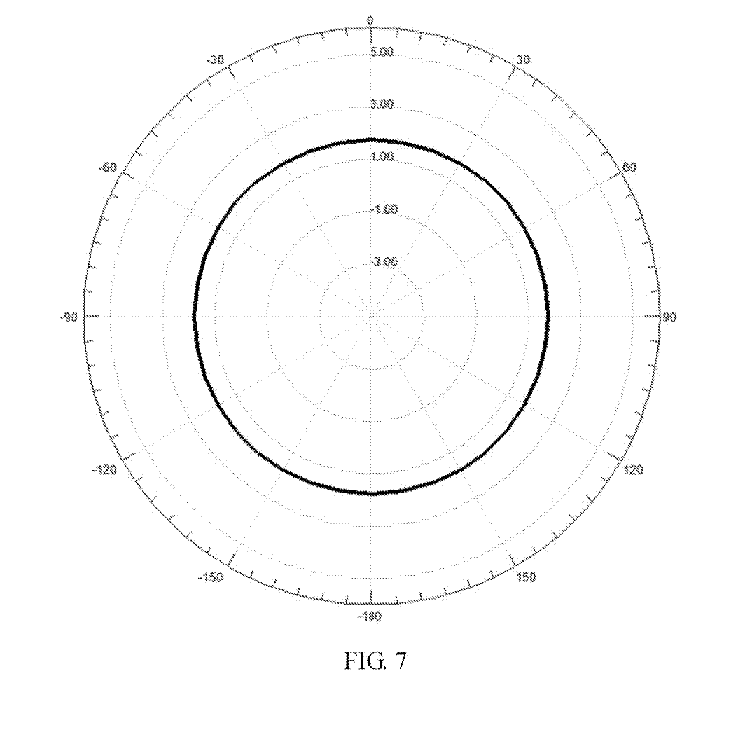

FIG. 7 is a diagram showing gain characteristics for an operating frequency of 800 MHz of frequency in horizontal direction of one embodiment of a conical antenna. As shown in FIG. 7, when the frequency is 800 MHz, gains in different directions of a horizontal plane are about 1.75 dB, the conical antenna has good omni-directional performance.

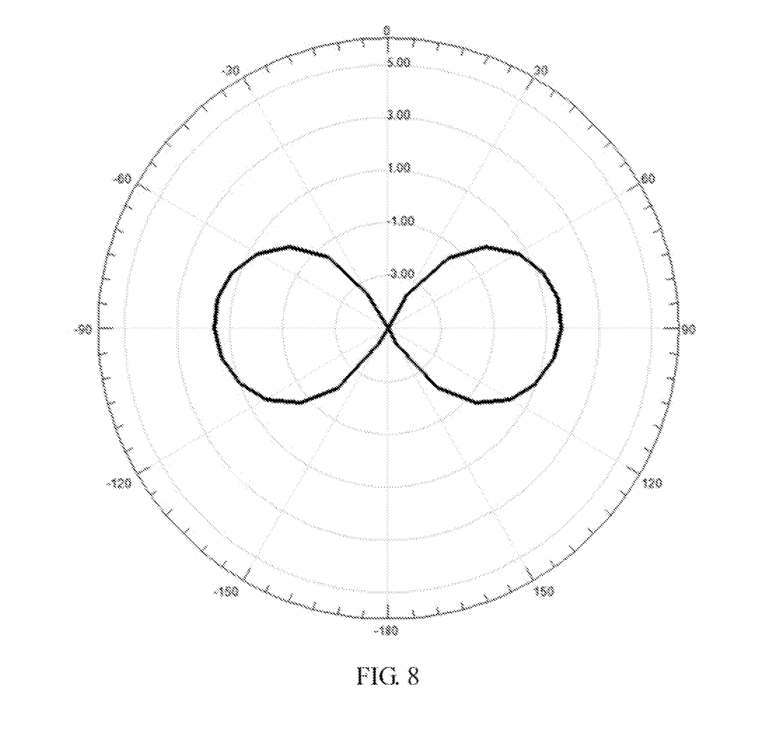

FIG. 8 is a diagram showing gain characteristics for an operating frequency of 800 MHz of frequency in vertical direction of one embodiment of a conical antenna. As shown in FIG. 8, when a direction is approaching an angle of positive or negative 90 degrees, the conical antenna reaches the highest gain.

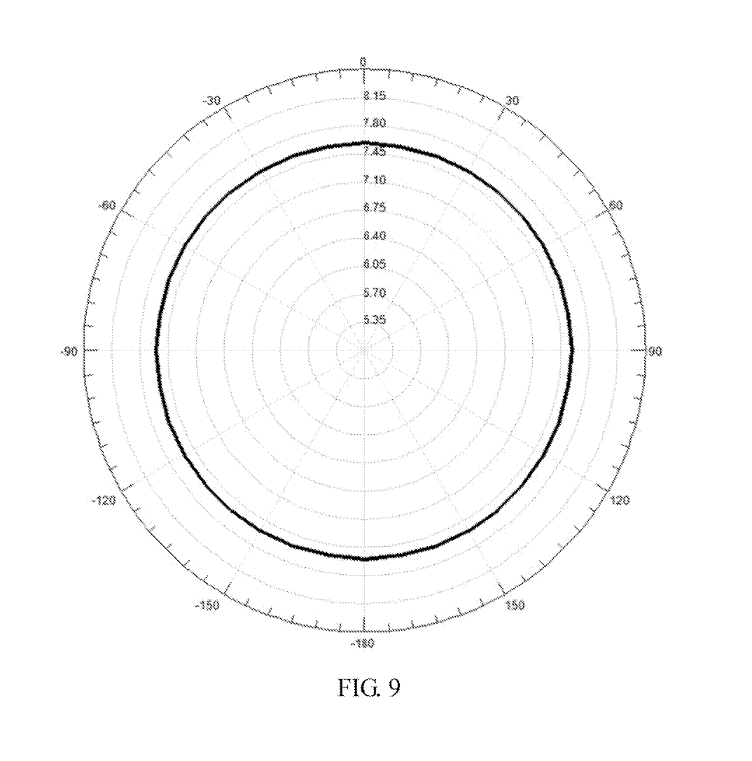

FIG. 9 is a diagram showing gain characteristics for an operating frequency of 2600 MHz of frequency in horizontal direction of one embodiment of a conical antenna. As shown in FIG. 9, when the frequency is 2600 MHz, gains in different directions of a horizontal plane are about 7.55 dB, the conical antenna has good omni-directional performance.

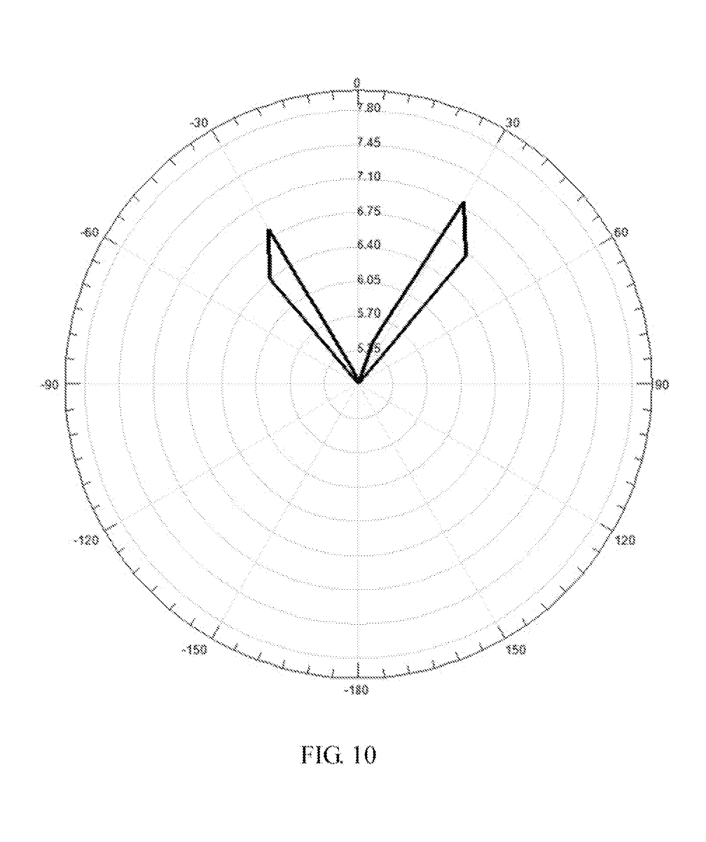

FIG. 10 is a diagram showing gain characteristics for an operating frequency of 2600 MHz of frequency in vertical direction of one embodiment of a conical antenna. As shown in FIG. 10, when a direction is approaching an angle of positive or negative 30 degrees, the conical antenna reaches a higher gain.

The foregoing disclosure of various embodiments has been presented for the purposes of illustration. It is not intended to be exhaustive or to limit the disclosure to the precise forms disclosed. Many variations and modifications of the embodiments described herein will be apparent to one of ordinary skill in the art in the light of the above disclosure. The scope of the disclosure is to be defined only by the claims appended hereto and their equivalents.

What is claimed is:

1. A conical antenna, comprising:
a chassis, wherein the chassis defines a via in a central portion of the chassis for feeding electromagnetic signals;
a main radiator, comprising a conical shaped first radiating portion, a cylindrical shaped second radiating portion, and a frustum cone shaped third radiating portion, for transmitting and receiving the electromagnetic signals; and
a ring resonator, disposed on the chassis;
wherein a sidewall of the first radiating portion connects with a sidewall of the via in the chassis through the ring resonator, the main radiator and the ring resonator configured to cooperatively resonate to generate a resonance frequency of the electromagnetic signals.

2. The conical antenna as claimed in claim 1, wherein the first radiating portion, the second radiating portion, and the third radiating portion are connected in series, and share a central axis.

3. The conical antenna as claimed in claim 2, wherein the central axis of the main radiator aligns to a central axis of the chassis.

4. The conical antenna as claimed in claim 2, wherein the central axis of the first radiating portion passes through a central of the ring resonator.

5. The conical antenna as claimed in claim 1, wherein a diameter of a bottom surface of the first radiating portion, diameters of a bottom surface and a top surface of the second radiating portion, and a shorter diameter of a surface of the third radiating portion are equal.

6. The conical antenna as claimed in claim 1, wherein the sidewalls of the first radiating portion, the second radiating portion and the third radiating portion collectively form a curved surface to make impedance characteristics of the main radiator match a preset frequency band.

7. The conical antenna as claimed in claim 1, wherein a bottom surface of the ring resonator overlaps with a surface of the chassis.

8. The conical antenna as claimed in claim 1, wherein the first radiating portion defines a hole in a vertex portion of the first radiating portion and an outer diameter of the hole in the vertex portion of the first radiating portion is equal to a diameter of the via of the chassis.

9. The conical antenna as claimed in claim 1, wherein the main radiator, the chassis and the ring resonator are integrally molded, the sidewall of the main radiator is of a conductive material and the main radiator inside is hollow.
